(19) United States
(12) Patent Application Publication
(10) Pub. No.: US 2026/0184937 A1
(43) Pub. Date: Jul. 2, 2026

(54) Supercavitation paint

(71) Applicant: Dewayne Coleman, Hillsboro, OR (US)

(72) Inventor: Dewayne Coleman, Hillsboro, OR (US)

(21) Appl. No.: 19/002,611

(22) Filed: Dec. 26, 2024

(51) Int. Cl. C09D 5/16; C09D 7/40; C09D 7/61; C09D 7/65; C09D 127/16; C09D 127/18

(52) U.S. Cl. CPC C09D 5/1668; C09D 7/61; C09D 7/65; C09D 7/67; C09D 7/69; C09D 7/70; C09D 127/16; C09D 127/18

(57) ABSTRACT

A supercavitation-enhancing paint formulation is disclosed for reducing hydrodynamic drag in underwater applications. The coating comprises a hydrophobic base, nano-additives for cavitation promotion, friction-reducing polymers, and gas-releasing agents. The formulation facilitates vapor layer formation around high-speed objects, improving propulsion efficiency. The paint is applied via a multi-layer process and heat-cured to enhance durability. This innovation enables sustained supercavitation without mechanical modifications, improving performance for underwater vehicles and projectiles.

### SUMMARY OF THE INVENTION

The proposed paint incorporates nanostructured hydrophobic materials, friction-reducing polymers, and cavitation-promoting additives. The coating is applied to the surface of underwater vehicles or equipment to create micro-scale bubbles that merge to form a stable supercavitation bubble under high-speed conditions. Key features include:
A hydrophobic base layer to repel water.
Nano-additives that promote nucleation of vapor bubbles.
Polymers that reduce surface friction to enhance bubble formation.

The paint is applied in multiple layers and cured under controlled conditions to ensure uniformity and durability

1. A paint formulation for underwater applications, comprising:
A hydrophobic base resin selected from the group consisting of fluoropolymer resins, polytetrafluoroethylene (PTFE), polyvinylidene fluoride (PVDF), and other similar resins providing water resistance and durability;
Nano-additives comprising silica nanoparticles, titanium dioxide nanoparticles, or similar materials, wherein the nano-additives are present in a concentration of 5-20% by weight, designed to enhance hydrophobicity and promote vapor bubble nucleation under high-velocity conditions;
Friction-reducing polymers selected from the group consisting of polyethylene glycol (PEG), polydimethylsiloxane (PDMS), fluorosilicone, and similar compounds, wherein the friction-reducing polymers are present in a concentration of 10-20% by weight of the total paint formulation;
Cavitation-promoting additives, comprising microbubbles selected from the group consisting of hollow glass microspheres, polymer microspheres, or polymer-based microbubbles, wherein the cavitation-promoting additives are present in a concentration of 5-15% by weight of the total paint formulation.”cm 2. “The paint formulation of claim 1, wherein the nano-additives are silica nanoparticles in a concentration of 10-15% by weight of the total paint formulation.”

3. “The paint formulation of claim 1, wherein the friction-reducing polymers are selected from PEG and PDMS.”

4. “The paint formulation of claim 1, wherein the cavitation-promoting additives comprise hollow glass microspheres with an average particle size of 1-5 microns.”cm 5. “A method of preparing and applying the paint formulation of claim 1, comprising the steps of:
Preparing the surface to remove contaminants and ensure optimal adhesion by sanding, degreasing, or other appropriate methods;
Applying a primer layer compatible with the hydrophobic base resin to enhance adhesion and durability of the final paint layer;
Applying the paint formulation using an application method selected from the group consisting of spraying. brushing, and dipping, to ensure even distribution of the paint over the surface;
Heat curing the applied paint at a temperature between 100° C. and 150° C. for a period of 1 to 2 hours to enhance bonding and durability, ensuring the formation of a strong, long-lasting coating that promotes cavitation.”

6. “The method of claim 5, wherein the primer layer is a polymeric primer that enhances adhesion of the paint formulation to surfaces commonly used in underwater applications, such as metal, polymer, or composite materials.”

6. Written Description and Support
Make sure your specification (description of the invention) supports each of your claims with clear examples and embodiments demonstrating how the paint formulation works and how it achieves its intended purpose (e.g., drag reduction, supercavitation, water resistance). This is crucial for the USPTO examiner to assess the full scope and operability of the invention.

7. Formal Language and Compliance
Use formal and precise language consistent with the USPTO guidelines. Phrases like “comprising” “consisting of” and “selected from the group consisting of” are standard in patent claims to define the boundaries of your invention.
